(19) United States
(12) Patent Application Publication
(10) Pub. No.: US 2025/0284311 A1
(43) Pub. Date: Sep. 11, 2025

(54) Mobile Device Shade

(71) Applicant: Dan Carter, Fort Worth, TX (US)

(72) Inventor: Dan Carter, Fort Worth, TX (US)

(21) Appl. No.: 18/598,862

(22) Filed: Mar. 7, 2024

(51) Int. Cl. G06F 1/16

(52) U.S. Cl. CPC G06F 1/1603

(57) ABSTRACT

A mobile device shade generally comprising a back panel, a top panel, a shade panel, two side panels, and a securing arrangement. The securing arrangement is designed to bias the two side panels to clamp onto a mobile device. The securing arrangement includes two buttons, a mechanical linkage, and a spring arrangement. Each of the two buttons is designed to be pressed toward one another in a pinching motion deform the two side panels outwardly to temporarily increase the space therebetween and permit the user to place the mobile device shade over an upper portion of a mobile device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shading and protective devices for mobile phones and more particularly pertains to a new mobile device shade for shading a mobile phone or other portable electronic device. In high temperature or very sunny areas, it is not uncommon for mobile phones or similar devices to be exposed to the sun for an extended period of time, especially when mounted in a hands-free car mount on a dashboard or similar. Not only does the sun make it difficult to see the display, the sunlight can heat the mobile device to the point it overheats and stops functioning altogether. Obviously this is an undesirable situation, especially for persons who travel or work in remote areas and rely on their mobile devices.

### (2) Description of Related Art Including Information Disclosed Under 37 CFR 1.97 and 1.98

The prior art relates to shading and protective devices for mobile phones. The prior art, as best understood, does not disclose a mobile device shade that can be clipped on with one hand.

### BRIEF SUMMARY OF THE INVENTION

An embodiment of the disclosure meets the needs presented above in a mobile device shade generally comprising a back panel, a top panel, a shade panel, two side panels, and a securing arrangement. The back panel is designed to be placed over an upper portion of the back of a mobile device. The top panel is designed to extend transversely from the back panel and to be placed over an upper side of a mobile device. The shade panel is designed to extend at a downward angle from the top panel and to provide shade for the front viewing surface of a mobile device to improve viewing and reduce heating of the mobile device. The two side panels are designed to extend transversely from each of the back panel, top panel, and shade panel. Each of the two side panels includes a flexible resilient material. The securing arrangement is designed to bias the two side panels to clamp onto a mobile device. The securing arrangement includes two buttons, a mechanical linkage, and a spring arrangement. The two buttons are positioned in the back panel and are slidable toward and away from one another. The mechanical linkage is designed and positioned to operatively connect the two spring-loaded buttons to the two side panels. The spring arrangement is designed and positioned to bias the two buttons away from one another and draw the two side panels toward one another via the mechanical linkage in a clamping action. Each of the two buttons is designed to be pressed toward one another in a pinching motion by a thumb and a finger of a user to thereby overcome the biasing force of the springs and deform the two side panels outwardly to temporarily increase the space therebetween and permit the user to place the mobile device shade over an upper portion of a mobile device.

The mobile device shade can be used with any mobile device by attachment to an upper portion thereof. One of the advantages of the design is that it can be clipped on with one hand. In general, a user must hold a mobile phone or similar device in one hand. That leaves only one free hand to clip on the mobile device shade. By using the securing arrangement with the pinchable buttons, a user can pinch together the buttons with his free hand and cause the sides of the mobile device shade to deform slightly outwardly. This increases the space so that the mobile device shade can be slid over a phone or tablet or similar device. Once in the desired position, the buttons are released and the shade clamps on by the biasing force of the springs. In addition, if the mobile phone shade is slightly narrower in width than the mobile device, the clamping force is increased to promote a secure connection.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a mobile device shade according to an embodiment of the disclosure.

FIG. 2 is a front view of an embodiment of the disclosure.

FIG. 3 is a rear view of an embodiment of the disclosure.

FIG. 4 is a perspective view of an embodiment of the disclosure.

FIG. 5 is a front view of an embodiment of the disclosure.

FIG. 6 is a close-up side view of an embodiment of the disclosure.

FIG. 7 is a cross-sectional view of an embodiment of the disclosure.

FIG. 8 is a cross-sectional view of an embodiment of the disclosure.

### DETAILED DESCRIPTION OF THE INVENTION

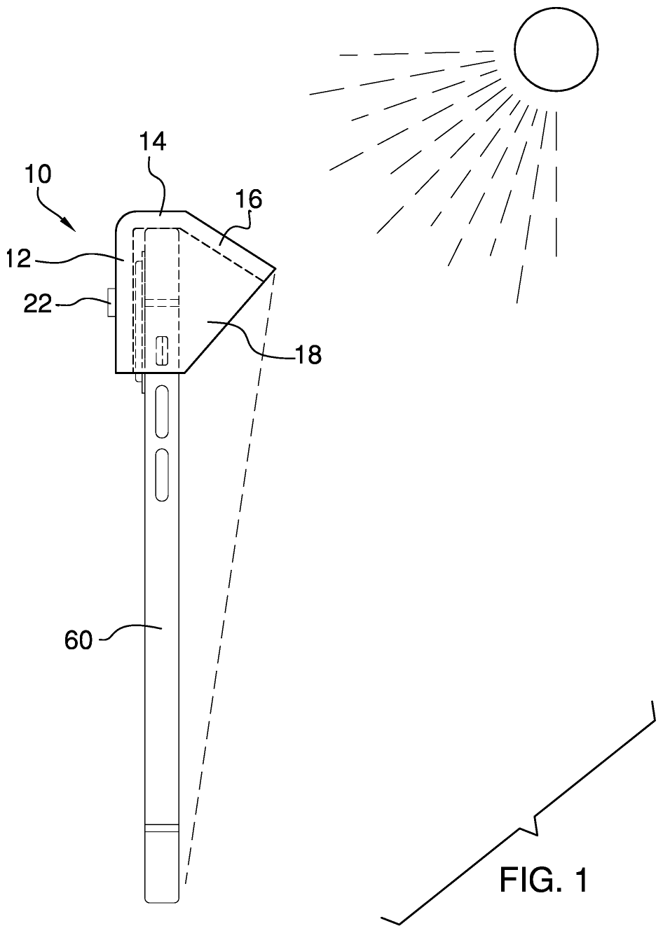

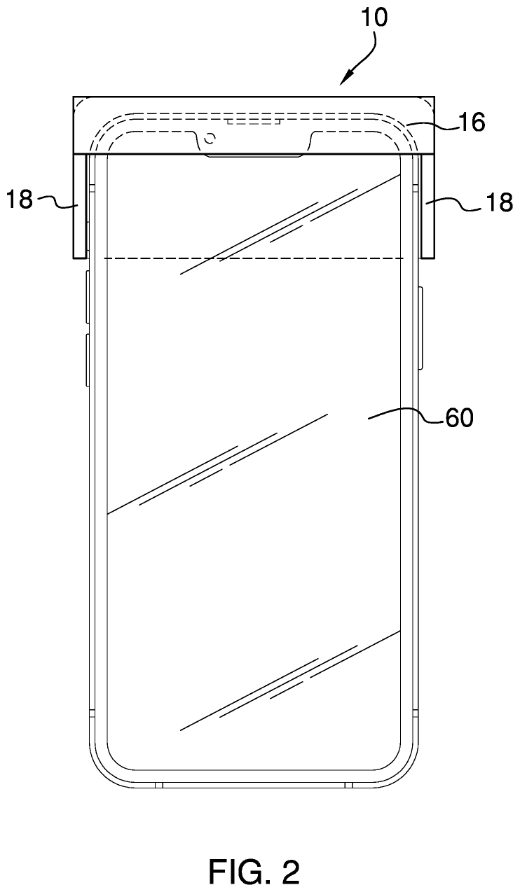

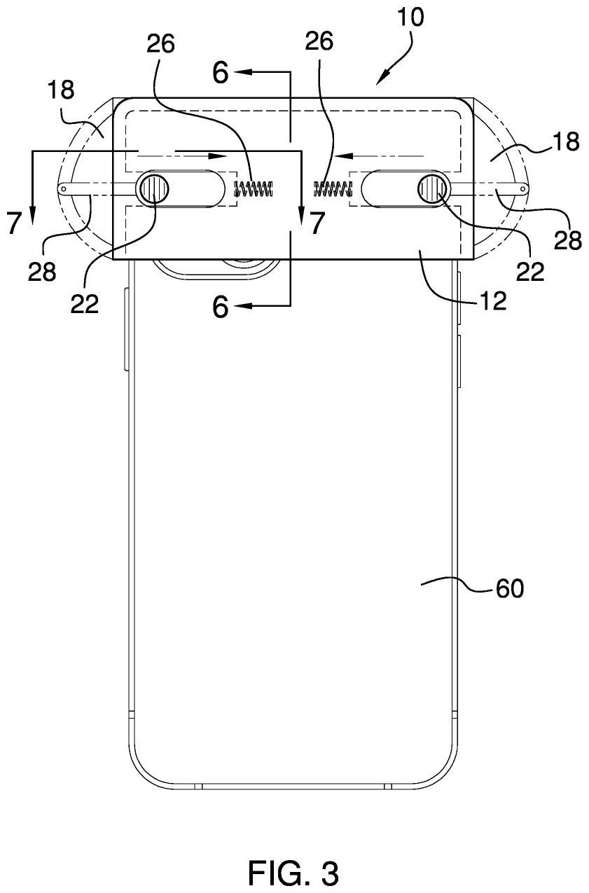

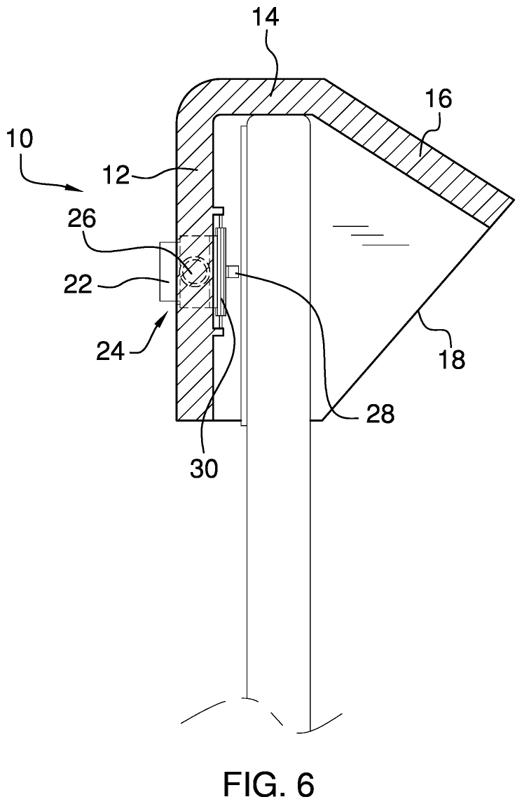

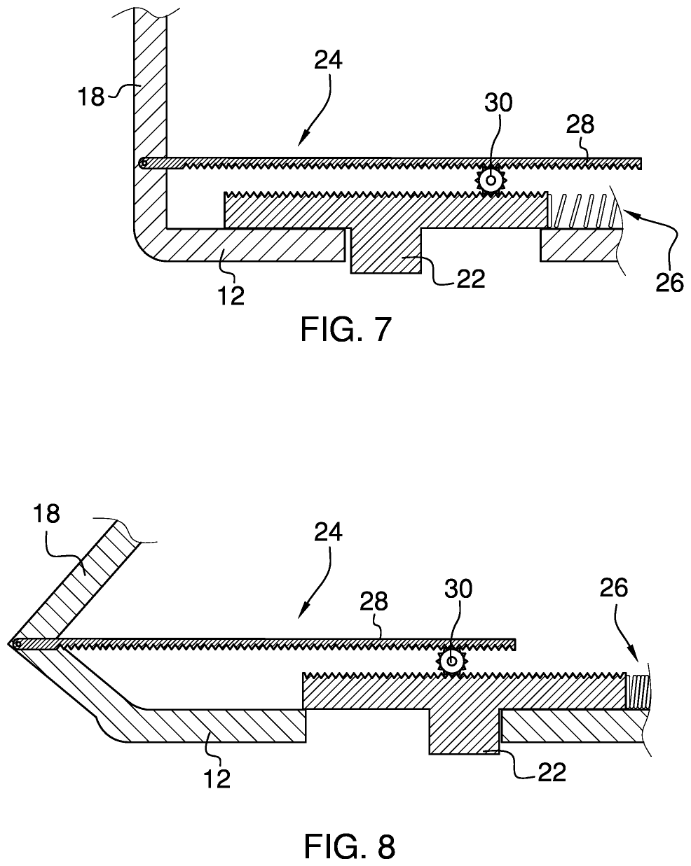

With reference now to the drawings, and in particular to FIGS. 1 through 8 thereof, a new mobile device shade embodying the principles and concepts of an embodiment of the disclosure and generally designated by the reference numeral 10 will be described.

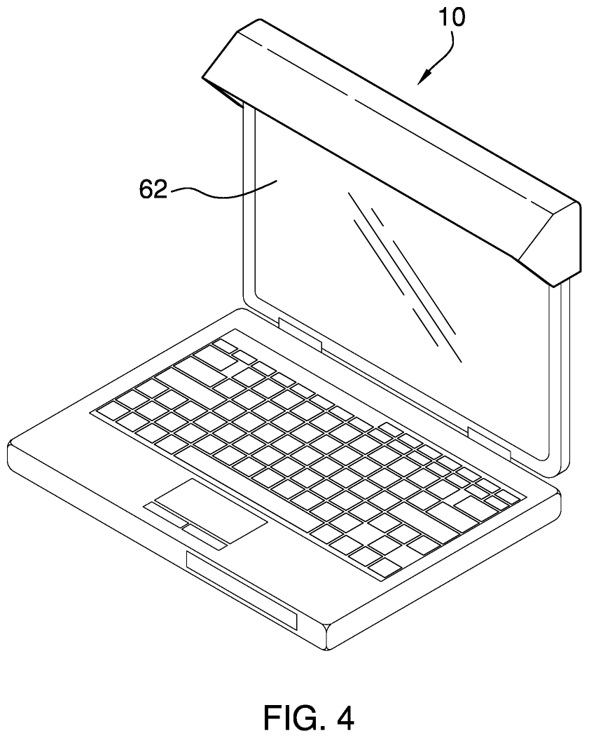

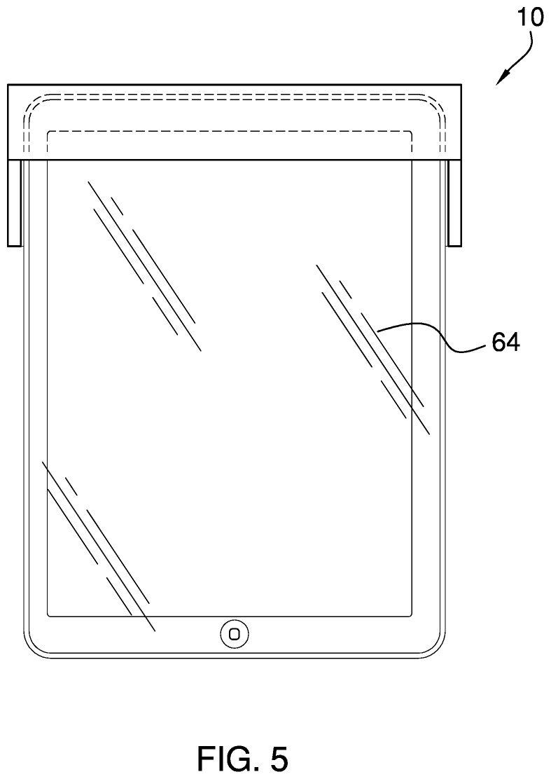

As best illustrated in FIGS. 1 through 8, the mobile device shade 10 generally comprises A mobile device shade includes: a back panel 12, a top panel 14, a shade panel 16, two side panels 18, and a securing arrangement 20. The back panel 12 is designed to be placed over an upper portion of the back of a mobile device. The top panel 14 is designed to extend transversely from the back panel 12 and to be placed over an upper side of a mobile device, such as a mobile phone or smartphone 60 (see FIGS. 1, 2, and 3), a laptop or portable computer 62 (see FIG. 4) or a tablet 64 (see FIG. 5). The shade panel 16 is designed to extend at a downward angle from the top panel 14 and to provide shade for the front viewing surface of a mobile device to improve viewing and reduce heating of the mobile device. The two side panels 18 are designed to extend transversely from each of the back panel 12, top panel 14, and shade panel 16. Each of the two side panels 18 includes a flexible resilient material. The securing arrangement 20 is designed to bias the two side panels 18 to clamp onto a mobile device. The securing arrangement 20 includes two buttons 22, a mechanical linkage 24, and a spring arrangement 26. The two buttons 22 are positioned in the back panel 12 and are slidable toward and away from one another. The mechanical linkage 24 is designed and positioned to operatively connect the two buttons 22 to the two side panels 18. The spring arrangement 26 is designed and positioned to bias the two buttons 22 away from one another and draw the two side panels 18 toward one another via the mechanical linkage 24 in a clamping action. Each of the two buttons 22 is designed to be pressed toward one another in a pinching motion by a thumb and a finger of a user to thereby overcome the biasing force of the springs and deform the two side panels 18 outwardly to temporarily increase the space therebetween and permit the user to place the mobile device shade 10 over an upper portion of a mobile device.

In accordance with at least one possible embodiment, each of the back panel 12, top panel 14, shade panel 16, and two side panels 18 includes a resilient, flexible, and heat-resistant material.

In accordance with at least one possible embodiment, the mechanical linkage 24 includes a lever 28 and cog 30 arrangement connected to a portion of each of the two side panels 18.

In accordance with at least one possible embodiment, the distance between the two side panels 18 is less than the width of a mobile device to which the mobile device shade is to be removably connected.

In use, the user holds a mobile phone or similar device in one hand. That leaves only one free hand to clip on the mobile device shade 10. The user can pinch together the buttons 22 with his free hand and cause the sides 18 of the mobile device shade 10 to deform slightly outwardly. This increases the space so that the mobile device shade 10 can be slid over a phone or tablet or similar device. Once in the desired position, the buttons 22 are released and the shade clamps on by the biasing force of the springs.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mobile device shade comprising:
a back panel configured to be placed over an upper portion of the back of a mobile device;
a top panel configured to extend transversely from said back panel and to be placed over an upper side of a mobile device;
a shade panel configured to extend at a downward angle from said top panel and to provide shade for the front viewing surface of a mobile device to improve viewing and reduce heating of the mobile device;
two side panels configured to extend transversely from each of said back panel, top panel, and shade panel;
each of said two side panels comprising a flexible resilient material;
a securing arrangement being configured to bias said two side panels to clamp onto a mobile device;
said securing arrangement comprising:
two buttons disposed in said back panel and being slidable toward and away from one another;
a mechanical linkage configured and disposed to operatively connect said two buttons to said two side panels; and
a spring arrangement configured and disposed to bias said two buttons away from one another and draw said two side panels toward one another via said mechanical linkage in a clamping action; and
each of said two buttons being configured to be pressed toward one another in a pinching motion by a thumb and a finger of a user to thereby overcome the biasing force of the springs and deform said two side panels outwardly to temporarily increase the space therebetween and permit the user to place the mobile device shade over an upper portion of a mobile device.

2. The mobile device shade of claim 1, wherein each of said back panel, top panel, shade panel, and two side panels comprises a resilient, flexible, and heat-resistant material.

3. The mobile device shade of claim 2, wherein said mechanical linkage comprises a lever and cog arrangement connected to a portion of each of said two side panels.

4. The mobile device shade of claim 3, wherein the distance between said two side panels is less than the width of a mobile device to which the mobile device shade is to be removably connected.

5. The mobile device shade of claim 4, wherein the mobile device shade is configured to fit onto a mobile phone.

6. The mobile device shade of claim 4, wherein the mobile device shade is configured to fit onto a laptop or similar portable computing device.

7. The mobile device shade of claim 1, wherein the distance between said two side panels is less than the width of a mobile device to which the mobile device shade is to be removably connected.
